(19) United States
(12) Patent Application Publication
(10) Pub. No.: US 2026/0031386 A1
(43) Pub. Date: Jan. 29, 2026

(54) Multi-cation Compositions of Halospinel Solid State Electrolytes

(71) Applicants: Nissan North America, Inc., Franklin, TN (US); University of Waterloo, Waterloo (CA)

(72) Inventors: Manas Likhit Holekevi Chandrappa, Sunnyvale, CA (US); Shigemasa Kuwata, Palo Alto, CA (US); Masanobu Uchimura, Palo Alto, CA (US); Linda Nazar, Waterloo (CA); Yubo Wang, Waterloo, (CA)

(21) Appl. No.: 18/787,381

(22) Filed: Jul. 29, 2024

(51) Int. Cl. H01M 10/0562

(52) U.S. Cl. CPC H01M 10/0562; H01M 2300/008

(57) ABSTRACT

A halospinel-based solid electrolyte for an all-solid-state battery has the following composition: LiₐM1_{b}M2_{c}Sc_{y}X₄, wherein X is one or more halogen; M1 is a divalent cation selected from the group consisting of Mg, Ca, Sr and Zn; M2 is one of a divalent, trivalent or tetravalent cation; 1.75≤a≤2.75; 0≤y≤0.375; 0.125≤b≤0.5; and 0.125≤c≤0.5.

### TECHNICAL FIELD

This disclosure relates to multi-cation compositions of halospinel-based solid electrolytes for batteries.

### BACKGROUND

Advances have been made toward high energy density batteries, including both lithium metal and lithium-ion batteries. However, these advances are limited by the underlying choice of materials and electrochemistry. Traditional lithium-ion batteries either use organic liquid electrolytes, prone to detrimental side reactions with active materials and are generally flammable, or ionic liquid electrolytes, with increased viscosities and lower ionic conductivity. All-solid-state batteries (ASSB) can address some or all of these issues, and can exhibit higher energy densities. However, the solid electrolytes used in ASSBs can have poor ionic conductivity and electrochemical stability, can be unstable against lithium metal anodes, and may react with environmental elements such as moisture and air. The materials used in the solid electrolytes can also be very costly.

### SUMMARY

Disclosed herein are implementations of halospinel-based solid electrolytes for ASSBs having high lithium-ion conductivity, no or low electron conductivity, large electrochemical windows with high oxidation stability, and a lower cost as they are made of earth abundant elements. The halospinel-based solid electrolytes disclosed herein may completely replace scandium or may partially replace scandium.

The halospinel-based solid electrolytes for an all-solid-state battery disclosed herein have the following composition:

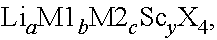

wherein X is one or more halogen; M1 is a divalent cation selected from the group consisting of Mg, Ca, Sr and Zn; M2 is one of a divalent, trivalent or tetravalent cation; 1.75≤a≤2.75; 0≤y≤0.375; 0.125≤b≤0.5; and 0.125≤c≤0.5.

The halospinel-based solid electrolytes disclosed herein include compositions in which M2 is a tetravalent cation selected from the group consisting of Ti, Zr, and Sn.

The halospinel-based solid electrolytes disclosed herein include compositions in which M2 is a trivalent cation selected from the group consisting of Fe and Al.

The halospinel-based solid electrolytes disclosed herein include compositions in which M2 is a divalent cation selected from the group consisting of Mg, Ca, Sr and Zn, wherein M1 and M2 are different cations.

The halospinel-based solid electrolytes disclosed herein include compositions in which y=0.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a cross-section schematic view of an ASSB cell as disclosed herein.

### DETAILED DESCRIPTION

Traditional lithium-ion batteries typically use either organic liquid electrolytes, prone to safety issues, or highly viscous ionic liquid electrolytes, that have lower ionic conductivity. Furthermore, the conventional choice of graphite-based anodes limits the specific energy of the battery to less than 300 Wh/kg. An ASSB with a lithium metal anode and a solid electrolyte can address both the safety issues as well as the demand for higher energy densities over a wider operating temperature range. The lithium metal anode has a theoretical gravimetric capacity approximately ten times higher than graphite-based anodes.

Inorganic solid electrolytes such as sulfide-based and oxide-based electrolytes are now known. However, they both fall short of providing the requisite ion conductivity, with oxide-based electrolytes suffering from high impedance and sulfide-based electrolytes suffering from poor stability.

Halide-based solid electrolytes are emerging as promising candidates for ASSBs, as they can provide ionic conductivity of >10⁻³ S cm⁻¹, good compatibility with oxide cathode materials, good chemical stability, and scalability. One such electrolyte, composed of lithium, scandium, and chlorine, conducts lithium ions well but conducts electrons poorly, an important combination for ASSBs to function without significantly losing capacity. However, improvements to ion conductivity and chemical stability continue to be investigated. In addition, scandium is scarce and in limited production, making it one of the most expensive natural elements.

The halospinel-based solid electrolytes for an ASSBs disclosed herein have high lithium-ion conductivity, no or low electron conductivity, large electrochemical windows, and a lower cost as they are made of earth abundant elements. The halospinel-based solid electrolytes disclosed herein may completely replace scandium or may partially replace scandium.

The halospinel-based solid electrolytes disclosed herein have the following composition:

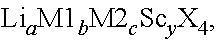

wherein X is one or more halogen; M1 is a divalent cation selected from the group consisting of Mg, Ca, Sr and Zn; M2 is one of a divalent, trivalent or tetravalent cation; 1.75≤a≤2.75; 0≤y≤0.375; 0.125≤b≤0.5; and 0.125≤c≤0.5.

The halospinel-based solid electrolyte composition may have a divalent cation selected from the group consisting of Mg, Ca, Sr and Zn as M1 and a tetravalent cation as M2, wherein M2 is selected from the group consisting of Ti, Zr, and Sn.

In some implementations, the halospinel-based solid electrolyte composition has Ca as M1 and Zr as M2. X can be Cl. As examples, the halospinel-based electrolyte can have one of the following compositions:

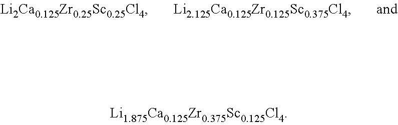

In some implementations, the halospinel-based solid electrolyte composition has Sr as M1 and Zr as M2. X can be Cl. As examples, the halospinel-based electrolyte can have one of the following compositions:

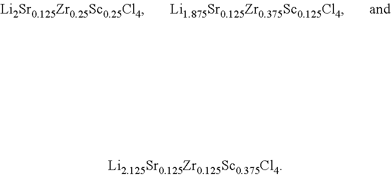

In some implementations, the halospinel-based solid electrolyte composition has Sr as Mi and Sn as M2. X can be Cl. As examples, the halospinel-based electrolyte can have one of the following compositions:

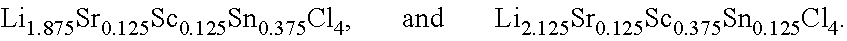

In some implementations, the halospinel-based solid electrolyte composition has Ca as M1 and Ti as M2. X can be Cl. As examples, the halospinel-based electrolyte can have one of the following compositions:

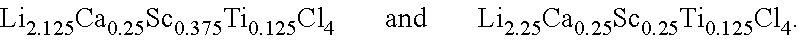

In some implementations, the halospinel-based solid electrolyte has no scandium such that y=0. As examples, the halospinel-based electrolyte can have one of the following compositions:

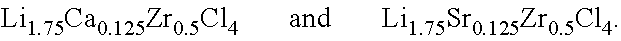

The halospinel-based solid electrolyte as disclosed herein may have a composition in which M1 is the divalent cation selected from the group consisting of Mg, Ca, Sr and Zn and M2 is a trivalent cation selected from the group consisting of Fe and Al.

In some implementations, the halospinel-based solid electrolyte composition may have Ca as M1 and Fe as M2. X can be Cl. As examples, the halospinel-based electrolyte may have one of the following compositions:

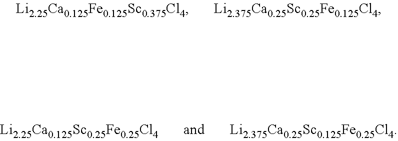

In some implementations, the halospinel-based solid electrolyte composition may have Ca as M1 and Al as M2. X can be Cl. As examples, the halospinel-based electrolyte may have one of the following compositions:

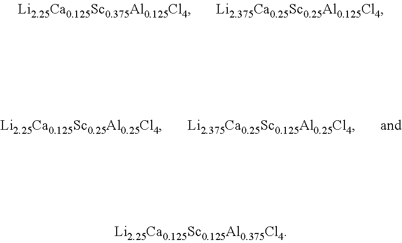

In some implementations, the halospinel-based solid electrolyte composition may have Sr as M1 and Fe as M2. X can be Cl. As an example, the halospinel-based electrolyte may have the following composition:

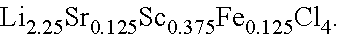

In some implementations, the halospinel-based solid electrolyte composition may have Sr as M1 and Al as M2. X can be Cl. As an example, the halospinel-based electrolyte may have the following composition:

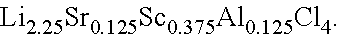

The halospinel-based solid electrolyte disclosed herein may have a composition in which M1 is a divalent cation selected from the group consisting of Mg, Ca, Sr and Zn and M2 is a divalent cation selected from the group consisting of Mg, Ca, Sr and Zn, wherein M1 and M2 are different cations.

In some implementations, the halospinel-based solid electrolyte may have one of the following compositions:

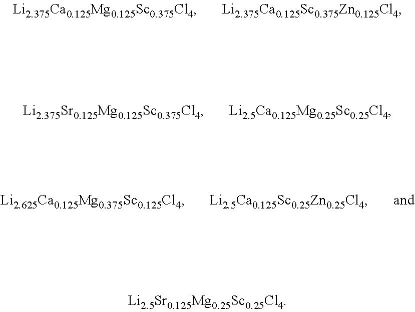

In some implementations, the halospinel-based solid electrolyte may not have any scandium, such that y=0. As an example, the halospinel-based electrolyte may have the following composition:

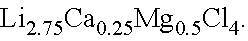

As discussed, the scandium may be totally replaced in the solid electrolyte, such that it has the following composition:
LiₐM1_{b}M2_{c}X₄, wherein X is one or more halogen; M1 is a divalent cation selected from the group consisting of Mg, Ca, Sr and Zn; M2 is one of a divalent, trivalent or tetravalent cation; 1.75≤a≤2.75; 0.125≤b≤0.5; and 0.125≤c≤0.5.

The halospinel-based solid electrolyte may have M1 as the divalent cation selected from the group consisting of Mg, Ca, Sr and Zn and M2 is a tetravalent cation selected from the group consisting of Ti, Zr, and Sn.

In some implementations, the halospinel-based solid electrolyte may have one of the following compositions:

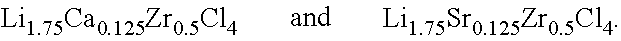

The halospinel-based solid electrolyte may have M1 as the divalent cation selected from the group consisting of Mg, Ca, Sr and Zn and M2 as a divalent cation selected from the group consisting of Mg, Ca, Sr and Zn, where M1 and M2 are different cations.

In some implementations, the halospinel-based solid electrolyte can have the following composition:

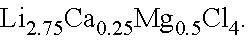

The halospinel-based solid electrolytes disclosed herein are stable, having energy above hull (meV/atom) of ≤30.

The halospinel-based solid electrolytes disclosed herein have an electrochemical window greater than 1.0 V and generally greater than 2.5 V and maintain an oxidation potential of greater than 4.1 V. The electrochemical stability window of a material is the voltage range in which it is neither oxidized nor reduced. It is measured by subtracting the reduction potential from the oxidation potential. The grand potential phase diagram approach using the density-functional theory (DFT) was used to calculate the electrochemical stability window of materials against lithium. Lithium grand potential phase diagrams represent phase equilibria that are open to lithium, which is relevant when the material is in contact with a reservoir of lithium. The electrochemical stability window of a material is the voltage range in which no lithiation or delithiation occurs, i.e. where lithium uptake is zero.

TABLE 1

| | | Electro- | | Li ion | Li ion |
|---|---|---|---|---|---|
| | Energy | chemical | Oxidation | activation | conductivity |
| | above hull | Window | Potential | barrier | @ 300K |
| Composition | (meV/atom) | (V) | (V) | (eV) | (mS/cm) |
| Li_{2.375}Ca_{0.125}Mg_{0.125}Sc_{0.375}Cl₄ | 15 | 3.36 | 4.27 | 0.315 | 1.034 |
| Li_{2.375}Ca_{0.125}Sc_{0.375}Zn_{0.125}Cl₄ | 18 | 2.33 | 4.27 | 0.360 | 0.387 |
| Li₂Ca_{0.125}Zr_{0.25}Sc_{0.25}Cl₄ | 18 | 2.52 | 4.27 | 0.338 | 0.658 |
| Li_{2.25}Ca_{0.125}Sc_{0.375}Al_{0.125}Cl₄ | 20 | 2.68 | 4.27 | 0.306 | 1.654 |
| Li_{2.25}Ca_{0.125}Sc_{0.375}Fe_{0.125}Cl₄ | 20 | 1.34 | 4.14 | 0.326 | 0.971 |
| Li_{2.375}Ca_{0.25}Sc_{0.25}Fe_{0.125}Cl₄ | 21 | 1.34 | 4.14 | 0.342 | 0.698 |
| Li_{2.375}Sr_{0.125}Mg_{0.125}Sc_{0.375}Cl₄ | 21 | 3.36 | 4.27 | 0.295 | 2.098 |
| Li_{2.125}Ca_{0.125}Zr_{0.125}Sc_{0.375}Cl₄ | 21 | 2.52 | 4.27 | 0.406 | 0.103 |
| Li_{2.375}Ca_{0.25}Sc_{0.25}Al_{0.125}Cl₄ | 21 | 2.68 | 4.27 | 0.345 | 0.610 |
| Li_{1.75}Ca_{0.125}Zr_{0.5}Cl₄ | 22 | 2.52 | 4.27 | 0.320 | 1.131 |
| Li_{1.875}Ca_{0.125}Zr_{0.375}Sc_{0.125}Cl₄ | 22 | 2.52 | 4.27 | 0.381 | 0.223 |
| Li₂Sr_{0.125}Zr_{0.25}Sc_{0.25}Cl₄ | 22 | 2.52 | 4.27 | 0.346 | 0.723 |
| Li_{2.5}Ca_{0.125}Mg_{0.25}Sc_{0.25}Cl₄ | 23 | 3.36 | 4.27 | 0.330 | 0.619 |
| Li_{2.25}Ca_{0.125}Sc_{0.25}Al_{0.25}Cl₄ | 24 | 2.68 | 4.27 | 0.373 | 0.304 |
| Li_{1.875}Sr_{0.125}Zr_{0.375}Sc_{0.125}Cl₄ | 25 | 2.52 | 4.27 | 0.304 | 2.299 |
| Li_{2.625}Ca_{0.125}Mg_{0.375}Sc_{0.125}Cl₄ | 25 | 3.36 | 4.27 | 0.427 | 0.026 |
| Li_{2.375}Ca_{0.25}Sc_{0.125}Al_{0.25}Cl₄ | 25 | 2.68 | 4.27 | 0.339 | 0.835 |
| Li_{2.125}Sr_{0.125}Zr_{0.125}Sc_{0.375}Cl₄ | 26 | 2.52 | 4.27 | 0.304 | 2.30 |
| Li_{2.25}Ca_{0.125}Sc_{0.25}Fe_{0.25}Cl₄ | 26 | 1.34 | 4.14 | 0.321 | 1.103 |
| Li_{2.25}Sr_{0.125}Sc_{0.375}Fe_{0.125}Cl₄ | 27 | 1.34 | 4.14 | 0.345 | 0.570 |
| Li_{2.5}Ca_{0.125}Sc_{0.25}Zn_{0.25}Cl₄ | 28 | 2.33 | 4.27 | 0.343 | 0.386 |
| Li_{1.75}Sr_{0.125}Zr_{0.5}Cl₄ | 28 | 2.52 | 4.27 | 0.273 | 4.178 |
| Li_{1.875}Sr_{0.125}Sc_{0.125}Sn_{0.375}Cl₄ | 28 | 1.46 | 4.27 | 0.283 | 5.227 |
| Li_{2.5}Sr_{0.125}Mg_{0.25}Sc_{0.25}Cl₄ | 28 | 3.36 | 4.27 | 0.366 | 0.316 |
| Li_{2.75}Ca_{0.25}Mg_{0.5}Cl₄ | 29 | 3.38 | 4.27 | 0.322 | 0.339 |
| Li_{2.125}Ca_{0.25}Sc_{0.375}Ti_{0.125}Cl₄ | 29 | 2.12 | 4.27 | 0.286 | 2.357 |
| Li_{2.25}Ca_{0.25}Sc_{0.25}Ti_{0.125}Cl₄ | 29 | 2.12 | 4.27 | 0.356 | 0.374 |
| Li_{2.25}Sr_{0.125}Sc_{0.375}Al_{0.125}Cl₄ | 29 | 2.71 | 4.27 | 0.312 | 1.871 |
| Li_{2.25}Ca_{0.125}Sc_{0.125}Al_{0.375}Cl₄ | 30 | 2.68 | 4.27 | 0.298 | 2.569 |
| Li_{2.125}Sr_{0.125}Sc_{0.375}Sn_{0.125}Cl₄ | 30 | 1.46 | 4.27 | 0.301 | 2.153 |
| Li_{2.375}Ca_{0.25}Sc_{0.125}Fe_{0.25}Cl₄ | 30 | 1.34 | 4.14 | 0.352 | 0.470 |

Several known methods can be used for the synthesis of halide electrolytes. These methods include, but are not limited to, mechanical ball-milling, solid-state sintering, and liquid-phase synthesis.

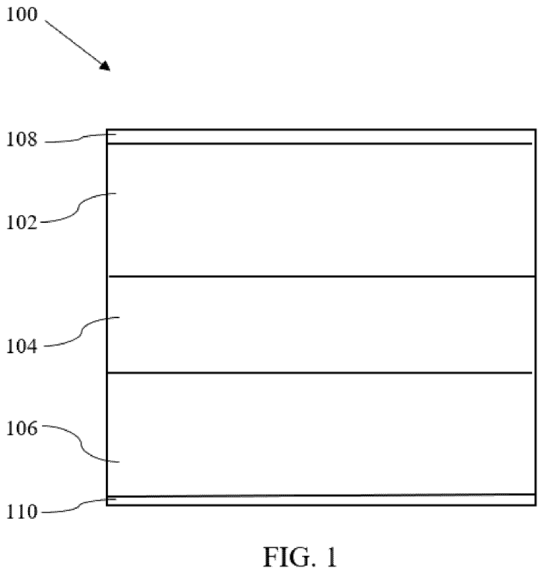

An ASSB cell 100 is illustrated schematically in cross-section in FIG. 1. The ASSB cell 100 of FIG. 1 is configured as a layered battery cell that includes as active layers a cathode active material layer 102, a halospinel-based solid electrolyte 104 as disclosed herein, and an anode active material layer 106. In addition to the active layers, the ASSB cell 100 of FIG. 1 may include a cathode current collector 108 and an anode current collector 110, configured such that the active layers are interposed between the anode current collector 110 and the cathode current collector 108. In such a configuration, the cathode current collector 108 is adjacent to the cathode active material layer 102, and the anode current collector 110 is adjacent to the anode active material layer 106. An ASSB can be comprised of multiple ASSB cells 100.

The anode active material in the anode active material layer 106 can be a layer of elemental lithium metal, a layer of a lithium compound(s) or a layer of doped lithium. The anode current collector 112 can be, as a non-limiting example, a sheet or foil of copper, nickel, a copper-nickel alloy, carbon paper, or graphene paper.

The cathode current collector 110 can be, as a non-limiting example, an aluminum sheet or foil, carbon paper or graphene paper.

The cathode active material layer 102 has cathode active material that can include one or more lithium transition metal oxides and lithium transition metal phosphates which can be bonded together using binders and optionally conductive fillers such as carbon black. Lithium transition metal oxides and lithium transition metal phosphates can include, but are not limited to, LiCoO₂, LiNiO₂, LiNi_{0.8}Co_{0.15}Al_{0.05}O₂, LiMnO₂, Li(Ni_{0.5}Mn_{0.5})O₂, LiNiₓCo_{y}Mn_{z}O₂, Spinel Li₂Mn₂O₄, LiFePO₄ and other polyanion compounds, and other olivine structures including LiMnPO₄, LiCoPO₄, LiNi_{0.5}Co_{0.5}PO₄, and LiMn_{0.33}Fe_{0.33}Co_{0.33}PO₄. The cathode active material layer 102 can be a sulfur-based active material and can include LiSO₂, LiSO₂Cl₂, LiSOCl₂, and LiFeS₂, as non-limiting examples.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A halospinel-based solid electrolyte having a following composition:
LiₐM1_{b}M2_{c}Sc_{y}X₄, wherein X is one or more halogen; M1 is a divalent cation selected from the group consisting of Mg, Ca, Sr and Zn; M2 is one of a divalent, trivalent or tetravalent cation; 1.75≤a≤2.75; 0≤y≤0.375; 0.125≤b≤0.5; and 0.125≤c≤0.5.

2. The halospinel-based solid electrolyte according to claim 1, wherein M2 is a tetravalent cation selected from the group consisting of Ti, Zr, and Sn.

3. The halospinel-based solid electrolyte according to claim 2, wherein M1 is Ca, and M2 is Zr and the halospinel-based electrolyte has one of the following compositions:

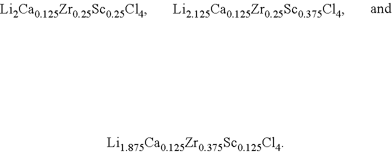

4. The halospinel-based solid electrolyte according to claim 2, wherein M1 is Sr and M2 is Zr and the halospinel-based electrolyte has one of the following compositions:

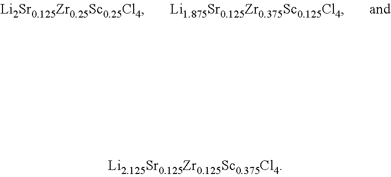

5. The halospinel-based solid electrolyte according to claim 2, wherein M1 is Sr and M2 is Sn and the halospinel-based electrolyte has one of the following compositions:

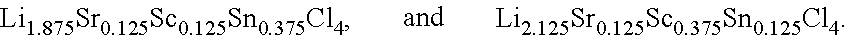

6. The halospinel-based solid electrolyte according to claim 2, wherein M1 is Ca and M2 is Ti and the halospinel-based electrolyte has one of the following compositions:

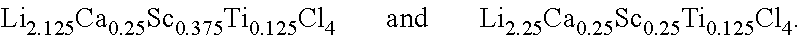

7. The halospinel-based solid electrolyte according to claim 2, wherein y=0, the halospinel-based electrolyte having one of the following compositions:

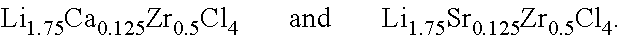

8. The halospinel-based solid electrolyte according to claim 1, wherein M2 is a trivalent cation selected from the group consisting of Fe and Al.

9. The halospinel-based solid electrolyte according to claim 8, wherein M1 is Ca, M2 is Fe, the halospinel-based electrolyte having one of the following compositions:

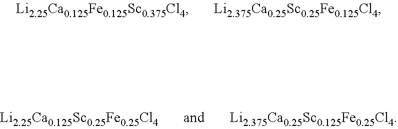

10. The halospinel-based solid electrolyte according to claim 8, wherein M1 is Ca, M2 is Al, the halospinel-based electrolyte having one of the following compositions:

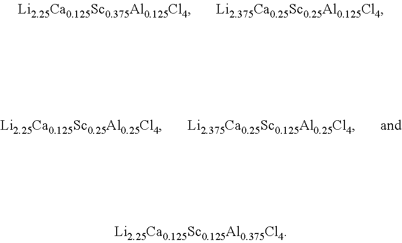

11. The halospinel-based solid electrolyte according to claim 8, wherein M1 is Sr, M2 is Fe, the halospinel-based electrolyte having the following composition:

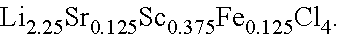

12. The halospinel-based solid electrolyte according to claim 8, wherein M1 is Sr, M2 is Al, the halospinel-based electrolyte having the following composition:

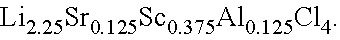

13. The halospinel-based solid electrolyte according to claim 1, wherein M2 is a divalent cation selected from the group consisting of Mg, Ca, Sr and Zn, wherein M1 and M2 are different cations.

14. The halospinel-based solid electrolyte according to claim 13, having one of the following compositions:

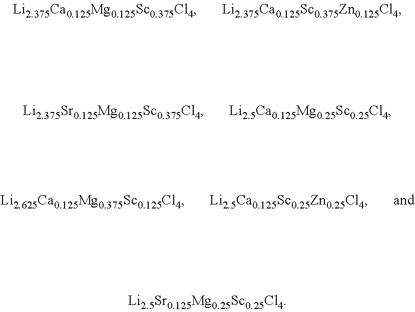

15. The halospinel-based solid electrolyte according to claim 13, wherein y=0, the halospinel-based electrolyte having the following composition:

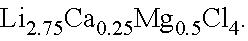

16. A halospinel-based solid electrolyte having a following composition:
LiₐM1_{b}M2_{c}X₄, wherein X is one or more halogen; M1 is a divalent cation selected from the group consisting of Mg, Ca, Sr and Zn; M2 is one of a divalent, trivalent or tetravalent cation; 1.75≤a≤2.75; 0.125≤b≤0.5; and 0.125≤c≤0.5.

17. The halospinel-based solid electrolyte according to claim 16, wherein M2 is a tetravalent cation selected from the group consisting of Ti, Zr, and Sn.

18. The halospinel-based solid electrolyte according to claim 17, having one of the following compositions:

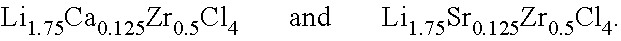

19. The halospinel-based solid electrolyte according to claim 16, wherein M2 is a divalent cation and M1 and M2 are different cations.

20. The halospinel-based solid electrolyte according to claim 19, having the following composition: [chemical structure]
